(19) United States
(12) Patent Application Publication
(10) Pub. No.: US 2025/0309410 A1
(43) Pub. Date: Oct. 2, 2025

(54) Ultra-Low-Cost Luffa Aluminum-Air Fuel Cell

(71) Applicant: Olurinde Ebenezer Lafe, Bentleyville, OH (US)

(72) Inventor: Olurinde Ebenezer Lafe, Bentleyville, OH (US)

(73) Assignee: Fuel Cells Global LTD, Bentleyville, OH (US)

(21) Appl. No.: 18/622,872

(22) Filed: Mar. 30, 2024

(51) Int. Cl. H01M 12/06; H01M 4/02; H01M 4/38; H01M 4/86; H01M 4/96; H01M 12/02; H01M 50/417

(52) U.S. Cl. CPC H01M 12/06; H01M 4/38; H01M 4/8626; H01M 4/96; H01M 12/02; H01M 50/417; H01M 2004/027; H01M 2004/8689; H01M 2300/0005; H01M 2300/0014

(57) ABSTRACT

A method and apparatus for generating electricity using an electrochemical cell with an aluminum wire as the anode, carbonized luffa sponge as air-cathode, a bioplastic electrolyte, and a common polyethylene sheet as membrane separator. The invention teaches the use of inexpensive materials, and simplified fuel cell construction.

### REFERENCES

Bockstie, L., Trevethan, D. & Zaromb, S., 1963. Control of Al corrosion in caustic solutions. Journal of The Electrochemical Society, 110 (4), pp. 267-271.

Cui, Y. et al., 2018. Developing porous carbon with dihydrogen phosphate groups as sulfur host for high performance lithium sulfur batteries. Journal of Power Sources, Volume 378, pp. 40-47.

Du Yuan, Jin Zhao, William Manalastas Jr., Sonal Kumar, Madhavi Srinivasan, 2020. Emerging rechageable aqueous aluminum ion battery: Status, challenges, and outlooks. Nano Materials Science, pp. 248-263.

Friesen, C. A. & Martinez, J. A. B., 2018. s.l. Patent No. 10090520.

Friesen, C. A., McDowell, F. & Bautista, M. J. A., 2016. Aluminum-Based Metal-Air Batteries. United States of America, U.S. Pat. No. 9,236,643 B2.

Giuseppe, Antonio Elia, Kostiantyn V. Kravchyk, Maksym V. Kovalenko, Joaquin Chacon, Alex Holland, Richard G. A. Wills, 2021. An overview and prospective on Al and Al-ion battery technologies. Journal of Power Resources.

Gu, X. et al., 2016. Multifunctional Nitrogen-Doped Loofah Sponge Carbon Blocking Layer for High-Performance Rechargeable Lithium Batteries. ACS Appl. Mater. Interfaces, 8 (25), pp. 15991-16001.

Jasso, K., Kazda, T. & Cudek, P., 2017. Using Natural Sorbent Luffa Cylindrica as a Conductive Component for Positive Electrodes of Lithium-Sulfur Batteries. ECS Transactions, 81 (1).

Jian, Y. et al., 2023. The giant flexoelectric effect in a luffa plant-based sponge for green devices and energy harvesters. Proceedings of the National Academy of Sciences, 120 (40).

Luan, P. et al., 2022. Compressible Ionized Natural 3D Interconnected Loofah Membrane for Salinity Gradient Power Generation. small, 18 (2).

Miller, Y., Tzidon, D. & Yadgar, A., 2021. United States of America, Patent No. 20210075078.

Mori, R., 2020. Recent Developments for Aluminum-Air Batteries. Electrochemical Energy Reviews, Volume 3, pp. 344-369.

Niksa, M. J., Niksa, A. J. & Noscal, J. M., 1990. Primary aluminum-air battery. United States of America, U.S. Pat. No. 492,5744.

Sasaki, K., 2015. United States of America, Patent No. 20150009365.

Song, S. et al., 2019. Loofah sponge as a high-loading 3D carbon matrix for lithium-sulfur batteries. Materials Letters, Volume 247, pp. 86-89.

Wang, Y. et al., 2023. Solid-state Al-air battery with an ethanol gel electrolyte. Green Energy & Environment, 8 (4), pp. 1117-1127.

Yang, J. et al., 2016. A free-standing sulfur-doped microporous carbon interlayer derived from luffa sponge for high performance lithium-sulfur batteries. J. Mater. Chem. A, 4 (37), pp. 14324-14333.

Zaromb, S., 1962. The use and behavior of aluminum anodes in alkaline primary batteries. Journal of The Electrochemical Society, 109 (12), pp. 1125-1130.

### FIELD OF INVENTION

The present invention generally relates to electricity generation, and more particularly to a method and apparatus for the conversion of the chemical energy stored in aluminum into electricity using metal-air electrochemical fuel cells.

### PRIOR ART

Fuel cells using metal-air have historically served as the robust building blocks for generators developed to meet practical applications. A metal-air fuel cell is fundamentally a primary battery. While the anode is a metal (e.g., aluminum, zinc, iron, magnesium, lithium, calcium, sodium, potassium, tin, and germanium), the cathode is oxygen drawn directly from ambient air. The result is a high energy density appliance because of the much-reduced weight of the cells.

Aluminum-air batteries were originally proposed by (Zaromb, 1962), and (Bockstie, et al., 1963). Developments in aluminum-air batteries were reviewed by (Mori, 2020) who provided background information on the advantages and disadvantages of several types of metal-air fuel cells and compared them with aluminum-air fuel cells. The strength of the high energy density of the aluminum-air fuel cell contrasts with the challenges in maintaining cathode stability and preventing performance-inhibiting water vapor ingress. While aqueous electrolytes provide excellent ionic conductivity and efficient aluminum dissolution, managing water loss and preventing dendrite formation have limited a broad adoption of aluminum-air fuel cells. (Wang, et al., 2023) tackled the issue of continuous aluminum corrosion during battery standby by using an ethanol gel electrolyte in an aluminum-air battery. Potassium hydroxide is the solute, and polyethylene oxide is the gelling agent.

Learned papers on the use of luffa sponge in electrochemical cells have been published by:
(Gu, et al., 2016) who developed multifunctional nitrogen-doped luffa sponge carbon blocking layer for high-performance rechargeable lithium batteries.
(Jian, et al., 2023) who reported giant flexoelectric effect in a luffa plant-based sponge for green devices and energy harvesters.
(Song, et al., 2019) who proposed luffa sponge as a high-loading 3D carbon matrix for lithium-sulfur batteries.
(Yang, et al., 2016) who described a free-standing sulfur-doped microporous carbon interlayer derived from luffa sponge for high performance lithium-sulfur batteries.
(Cui, et al., 2018) who developed porous carbon with dihydrogen phosphate groups as sulfur host for high performance lithium sulfur batteries.
(Luan, et al., 2022) who reported compressible ionized natural 3D interconnected luffa membrane for salinity gradient power generation.
(Jasso, et al., 2017) who used natural sorbent luffa cylindrica as a conductive component for positive electrodes of lithium-sulfur batteries.

Patents which taught different implementations of the aluminum-air fuel cell include:
(Niksa, et al., 1990) which describes an aqueous electrolyte aluminum-air battery with a consumable aluminum anode and an air cathode. The battery has a hydrophobic membrane that prevents the electrolyte from leaking out and allows hydrogen to escape. The battery is mechanically rechargeable by replacing the anode and/or the electrolyte.
(Miller, et al., 2021) which discloses aluminum-air battery units and stacks with frames that provide robust structural support and hermetic sealing for the anode and the cathode. The frame has a protective strap that protects the edges of the anode from corrosion and a trapezoidal shape that presses the strap against the anode. The anode can be replaced after electrolyte evacuation while maintaining the stack sealed.
(Sasaki, 2015) which proposes an aluminum-air battery and accumulator system that uses an electrolyte comprising a mixture of water and an ionic liquid. The system has a device for circulating the electrolyte between the battery and the accumulator, and a device for controlling the temperature and the pH of the electrolyte. The system can improve the performance and the lifetime of the battery.
(Friesen & Martinez, 2018) which relates to aluminum-based metal-air batteries that use an anode comprising an aluminum alloy and a cathode comprising a bifunctional catalyst. The batteries can have high energy density, high power density, and long cycle life. The batteries can also be recharged by electrochemical or mechanical methods.
(Friesen, et al., 2016) describes an aluminum-air cell using an organic solvent electrolyte that forms a protective layer on the aluminum anode during non-use, enabling efficient oxidation during discharge.

### BACKGROUND OF THE INVENTION

An aluminum-air fuel-cell is an electrochemical apparatus with cathode consisting of oxygen extracted from the air, an alkaline electrolyte, and aluminum as the anode and the fuel. Aluminum-air fuel cells hold immense potential as a sustainable energy solution. Aluminum is a readily available and inexpensive resource, making an aluminum-air fuel cell a cost-effective energy solution. The major challenge facing the widespread adoption of aluminum-air electrochemistry for practical electricity generation is the anodic aluminum self-corrosion. The electricity production of the fuel cell is severely inhibited by the reaction of the aluminum with water/oxygen in the electrolyte resulting in the production of hydrogen gas. The electrochemical reactions in an aluminum-air fuel cell, with an alkaline electrolyte, is described by (Mori, 2020):
Anode: Al→Al³⁺+3e⁻.
Cathode: O₂+2H₂O+4e⁻→4OH⁻
Overall: 4Al+3O₂+6H₂O→4Al(OH)₃

Hydroxide ions are transported from the cathode to the anode through the medium of the electrolyte. The electricity production capacity, as well as the safety and stability of the fuel cell, is strongly dependent on the nature of the electrolyte.

The typical aluminum-air fuel-cell normally converts a small fraction of the 8.1 kWh of chemical energy inherent in every kilogram of anodic aluminum into electricity. This invention teaches the use of dual electrolytes, and a thin anodic aluminum wire, to produce an energy efficient fuel cell. In the anodic chamber is an anolyte consisting of a bioplastic electrolyte derived from a compound solution of sodium hydroxide or potassium hydroxide (KOH) and an organic binder. The cathodic chamber consists of carbonized luffa sponge. The cathode is separated from the anodic chamber by a low-cost membrane separator. Vinegar is the catholyte. The use of the bioplastic anolyte significantly reduces self-corrosion, limits parasitic gas production, and improves the performance of the aluminum-air fuel cell. Optimizing energy production per unit weight of anodic aluminum results in efficient ultra-low-cost electricity generators built using the aluminum-air fuel cell taught in this invention.

### SUMMARY OF THE INVENTION

According to the present invention there is provided a method of generating electricity from an electrochemical cell comprising a tubular anodic inner chamber mesh, an anodic aluminum wire, a bioplastic anolyte, a membrane separator, a carbonized catholyte-soaked luffa sponge air-cathode, and an exterior mesh enclosure.

An advantage of the present invention is the provision of a method and apparatus for converting the intrinsic chemical energy of aluminum into electricity.

Another advantage of the present invention is the provision of a method and apparatus for electricity generation which provides maximal conversion of the chemical energy in aluminum into electricity.

Still another advantage of the present invention is the provision of a method and apparatus for electricity generation utilizing a bioplastic electrolyte which enhances the electrochemical reactions by suppressing anodic corrosion and the evolution of hydrogen.

Still another advantage of the present invention is the provision of a method and apparatus for electricity generation which utilizes an aluminum wire as the solid fuel.

Still another advantage of the present invention is the provision of a method and apparatus for electricity generation which utilizes a carbonized luffa sponge as cathode.

Still another advantage of the present invention is the provision of a method and apparatus for electricity generation which utilizes a low-cost polyethylene membrane separator.

Still other advantages of the invention will become apparent to those skilled in the art upon reading and understanding the following detailed description, accompanying drawings and appended claims.

### BRIEF DESCRIPTION OF DRAWINGS

The invention may take physical form in certain parts and arrangements of parts, a preferred embodiment and method of which will be described in detail in this specification and illustrated in the accompanying drawings which form a part hereof, and wherein:

FIG. 1 is an illustration of the isometric view of the Fuel Cell;

FIG. 2 is an illustration of the horizontal cross-section of the Fuel Cell;

FIG. 3 is an illustration of the vertical cross-section of the Fuel Cell;

FIG. 4 is an image of hollowed-out luffa sponge to be carbonized as air-cathode for the Fuel Cell;

FIG. 5 is an illustration of the steps involved in the construction of the Fuel Cell.

### DETAILED DESCRIPTION OF THE INVENTION

It should be appreciated that while a preferred embodiment of the present invention will be described with reference to aluminum-air fuel cell, other metal-air electrochemical cells are also suitable for use in connection with the present invention. These include zinc-air, iron-air, magnesium-air, lithium-air, calcium-air, sodium-air, potassium-air, tin-air, and germanium-air fuel cells.

In accordance with a preferred embodiment, the present invention teaches the generation of electricity using an electrochemical cell comprising: a) an inner chamber made of a mesh tube; b) an anode consisting of an aluminum wire; c) a bioplastic anolyte made from a compound solution of sodium hydroxide (NAOH) or potassium hydroxide (KOH), and a binder derived from Manihot Esculenta (known as Cassava); d) a vinegar-based catholyte; e) an air-cathode medium made from a carbonized luffa sponge; f) a membrane separator; and g) an exterior mesh enclosure.

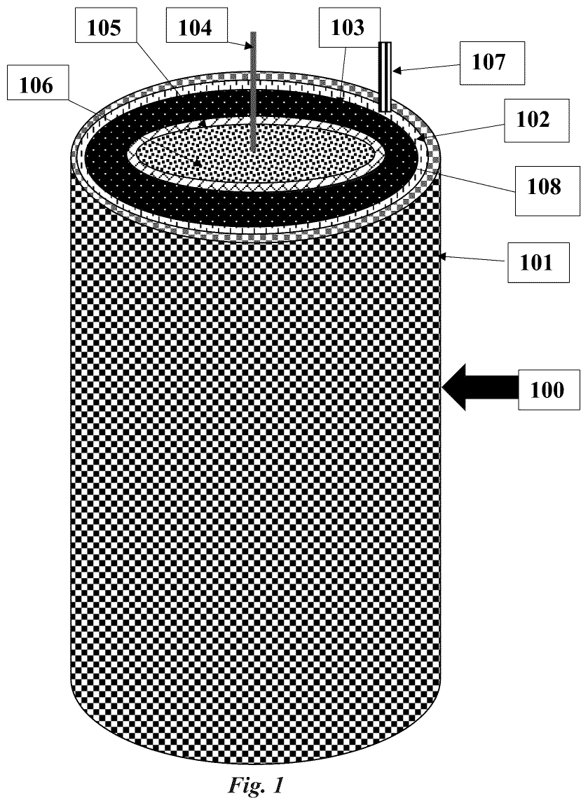

Referring now to the drawings wherein the showings are for the purposes of illustrating a preferred embodiment of the invention only and not for purposes of limiting same, FIG. 1 is an illustration of the isometric view of fuel cell 100. At the upper end of the tube, the aluminum anode 104, the fuel for the electricity generation, is dipped into electrolyte 106. The top end of the anodic aluminum 104 jots out of the anodic chamber 105 to serve as the negative terminal of the electrochemical cell. Bioplastic anolyte 106 occupies the entirety of anodic chamber 105. According to the embodiment of this invention, the bioplastic anolyte 106 is injected into anodic chamber 105.

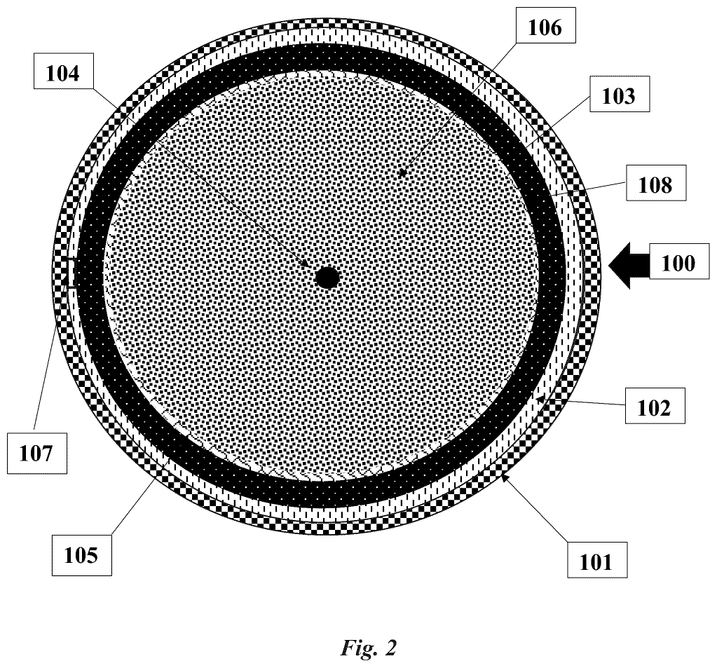

Referring now to FIG. 2:
1. CURRENT COLLECTOR 102. According to the preferred embodiment of this patent, current collector 102 consists of a perforated conductive metal tube, made preferably by folding plain copper sheet, copper foil, or mesh of copper into a cylindrical shape. Current collector 102 is sandwiched between exterior container 101 and cathode 103.
2. AIR-CATHODE 103. The air-cathode is a carbonized hollowed-out luffa sponge.
3. ALUMINUM ANODE 104. According to the preferred embodiment of this patent, the anode is pure aluminum or an alloy of aluminum in the form of a wire of diameter not exceeding 3 mm (Gauge 9).
4. ANODIC CHAMBER 105. According to this invention, anodic chamber 105 consists of a Rigid Mesh Plastic Tube. This is typically a perforated plastic tube of specific diameter and thickness. The degree of the tubular perforations determines the percentage of the circumferential area (Open Area) available for effective ionic transport through membrane separator 108.
5. BIOPLASTIC ANOLYTE 106. According to this invention, the anolyte is formulated by mixing x parts by volume of powdery NAOH or KOH with y parts by volume of Manihot Esculenta (known as Cassava), with z parts by volume of H₂O. The mixture is mechanically stirred until a uniformly smooth compound is achieved.
6. POSITIVE TERMINAL 107: According to the preferred embodiment of this patent, positive terminal 107, is a thin nickel strip (thickness 0.15 mm, width 8 mm) attached to current collector 102.
7. MEMBRANE SEPARATOR 108. The preferred membrane separator, according to this invention, is common polyethylene material.

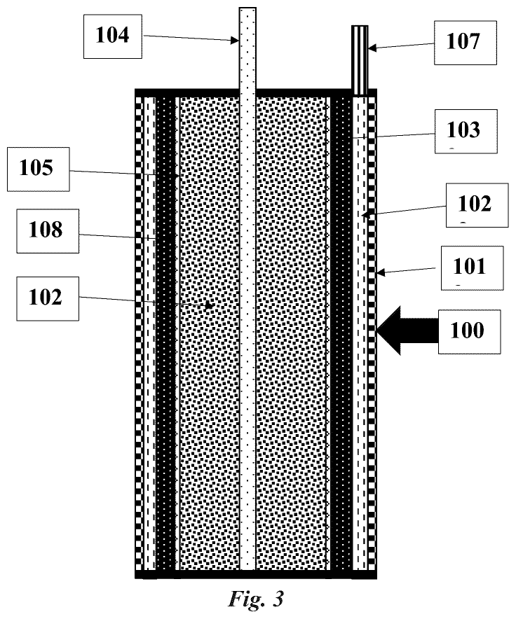

Referring now to FIG. 3:
1. EXTERIOR CONTAINER 101. The exterior container 101, according to this invention, can consist of:
   a. Rigid Plastic Mesh Tube-thickness 1.6 mm to 2.5 mm; open area 37% to 48%.
   b. Fiberglass Mesh Tube—(13 Mesh)—thickness 0.3 mm

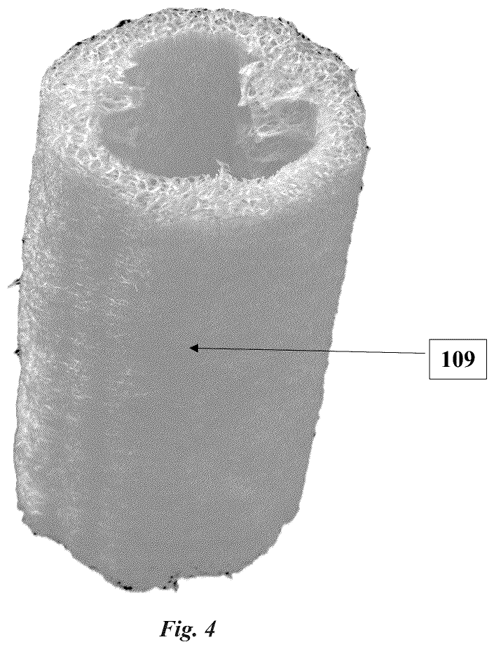

Referring now to FIG. 4: Luffa Sponge 109. According to the preferred embodiment of this patent, luffa sponge 109, is hallowed out organic Thaumatococcus Daniellii. The carbonized luffa sponge 109 can be sliced into strips to fit the internal dimensions of exterior container 101. Carbonization can be achieved by:
a. Soaking the luffa sponge in a carbon ink formed by a compound mixture of activated carbon powder, manganese dioxide, and vinegar.
b. Placing the luffa sponge in a muffle oven.

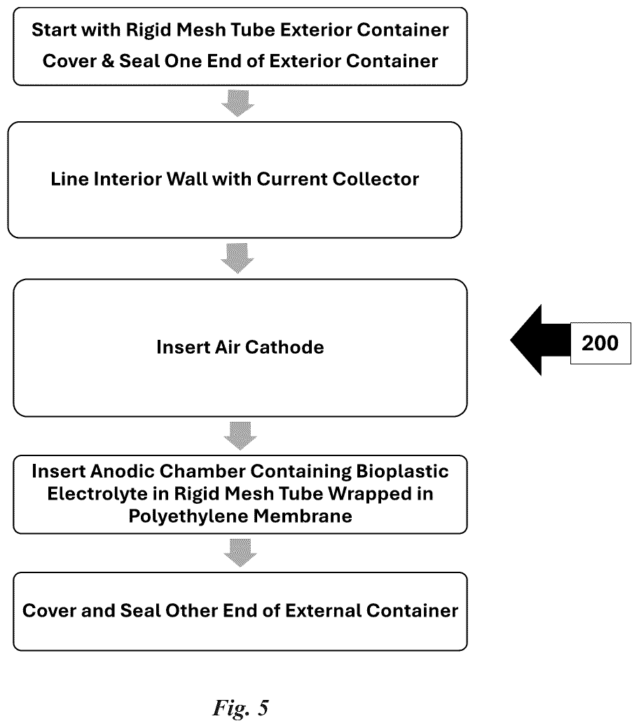

Referring now to FIG. 5: The steps 200 involved in the construction of the luffa

aluminum-ion fuel cell 100 are:
1. Start with Rigid Mesh Tube Exterior Container 101
2. Cover & Seal One End of Exterior Container 101
3. Line Interior Wall with Current Collector 102
4. Insert Air Cathode 103
5. Insert Anodic Chamber Containing Bioplastic Electrolyte in Rigid Mesh Tube 105 Wrapped in Polyethylene Membrane 108
6. Cover and Seal Other End of External Container 101

### EXAMPLE

To establish the characteristics of the fuel cell, according to the invention disclosed herein, a discharge test was conducted on a cell of distinct size configuration. In the following example, the anolyte is from the mixture of 250 ml of sodium hydroxide, 250 ml of Manihot Esculenta (Cassava) starch, with 500 ml of H₂O. The catholyte is vinegar. The air-cathode is a hollowed-out luffa sponge carbonized by soaking in carbon ink. The carbon ink is made from a mixture of activated carbon powder and manganese dioxide in a 2:1 (by weight) ratio.
Diameter of Exterior Container: 50 mm
Length of External Container: 150 mm
Anode: Aluminum wire—2 mm diameter (Gauge 12)
Current Collector: Copper sheet sandwiched by conductive copper foil
Discharge current: 100mA
Test duration: 2,861 minutes
Current Capacity: 4,768 mAh
Energy Produced: 3,479 mWh
Average Operating Voltage: 0.73V

The present invention has been described with reference to a preferred embodiment. Obviously, modifications and alterations will occur to others upon a reading and understanding of this specification. It is intended that all such modifications and alterations be included insofar as they come within the scope of the appended claims or the equivalents thereof.

1. A method of generation of electricity using a dual-electrolyte electrochemical fuel cell comprising: an inner chamber made of a mesh tube; an anode consisting of aluminum wire; a bioplastic anolyte made from a compound solution of sodium hydroxide (NAOH) or potassium hydroxide (KOH), and a binder derived from Manihot Esculenta (known as Cassava); vinegar-based catholyte; air-cathode made from an organic porous material; a membrane separator; and exterior mesh enclosure.

2. A method according to claim 1, wherein the anolyte is a compound solution of sodium hydroxide (NAOH) or potassium hydroxide (KOH), and a binder derived from Manihot Esculenta (known as Cassava).

3. A method according to claim 2, wherein the anodic chamber consists of a rigid mesh tube filled with solidified bioplastic electrolyte.

4. A method according to claim 1, wherein the air-cathode consists of carbonized hollowed-out luffa sponge.

5. A method according to claim 1, wherein the membrane separator is a polyethylene sheet.

6. A method according to claim 1, wherein the anode is an aluminum wire.
